(19) United States
(12) Patent Application Publication
(10) Pub. No.: US 2005/0157184 A1
(43) Pub. Date: Jul. 21, 2005

(54) Image capturing apparatus

(75) Inventors: Hideaki Nakanishi, Mishima-gun (JP); Hisanori Itoh, Osaka-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA PHOTO IMAGING, INC.

(21) Appl. No.: 10/889,904

(22) Filed: Jul. 13, 2004

(30) Foreign Application Priority Data
Jan. 21, 2004 (JP) 2004-012754

(51) Int. Cl. H04N 5/225; G03B 13/02

(52) U.S. Cl. 348/220.1; 348/373; 396/374

(57) ABSTRACT

An image capturing apparatus for capturing and recording images, including a function switch section for switching at least first and second image capturing functions, a first operation member which is operated to start image capturing in the first image capturing function or the second image capturing function, and a second operation member which is operated to execute functions other than the first and second image capturing functions, wherein on condition that the function switch section is switched to execute image capturing in the first image capturing function in response to operation of the first operation member, image capturing in the second image capturing function is executed when the second operation member is operated.

### RELATED APPLICATION

This application is based on Japanese Patent Application No. 2004-12754, the content of which is incorporated herein by reference.

### BACKGROUND OF THE INVENTION

The present invention relates to an image capturing apparatus such as digital cameras and cell phones with built-in camera, which has at least two types of image capturing functions including still image capturing and moving image capturing.

In most of the conventional digital still cameras (DSCs), image capturing mode can be switched between still image capturing and moving image capturing through operation of members such as dials and/or slide switches. Moreover, start/stop of recording (i.e., start/stop of still image capturing and moving image capturing, and start/stop of voice recording) is implemented by pressing a release button (or a shutter button). Further, in most of the cell phones with built-in camera and the like, the image capturing mode is switched in a menu hierarchy displayed in a display section.

In addition, a camera provided with separate release buttons each for still images and moving images has been proposed. Further, a camera provided with a button for still image recording start preparation has been proposed.

In the aforementioned image capturing apparatus having at least two types of image capturing functions including the still image mode and the moving image mode, users may desire to instantly switch to the moving image mode during image capturing in the still image mode, or contrary to this, users may desire to instantly switch to the still image mode during image capturing in the moving image mode. In such cases, if the image capturing apparatus is provided with separate release buttons for still images and moving images, users might confuse as to which button to press or misoperate.

Moreover, if the image capturing apparatus is provided with a plurality of release buttons, the apparatus may suffer upsizing and increased costs.

### SUMMARY OF THE INVENTION

Accordingly, in order to solve the above problem, a first aspect of the present invention is to provide an image capturing apparatus for capturing and recording images, including a function switch section for switching at least first and second image capturing functions,

a first operation member which is operated to start image capturing in the first image capturing function or the second image capturing function, and

a second operation member which is operated to execute functions other than the first and second image capturing functions, wherein

on condition that the function switch section is switched so as to execute image capturing in the first image capturing function in response to operation of the first operation member, image capturing in the second image capturing function is executed when the second operation member is operated.

In the image capturing apparatus in the first aspect of the present invention,

on condition that the function switch section is switched so as to execute image capturing in the first image capturing function in response to operation of the first operation member, image capturing in the second image capturing function may be executed when the first operation member is operated at the same time as the second operation member is operated.

In the image capturing apparatus in the first aspect of the present invention, on condition that the function switch section is switched so as to execute image capturing in the first image capturing function in response to operation of the first operation member, image capturing in the second image capturing function may be executed when the first operation member is operated in a specified period of time after the second operation member is operated.

Further in the image capturing apparatus in the first aspect of the present invention,

the first operation member may be a release button, and the second operation member may be a button other than the release button.

Further in the image capturing apparatus in the first aspect of the present invention,

the function switch section may be a rotating or sliding-type operation member.

Further in the image capturing apparatus in the first aspect of the present invention,

the function switch section may be composed of a function selection member for selecting and determining a function and a direction indication member for indicating a direction. Switching of functions by the function switch section may be achieved by selecting and determining items that are displayed in a display section provided in the image capturing apparatus with use of the function selection member and the direction indication member.

Further in the image capturing apparatus in the first aspect of the present invention,

image capturing in the first image capturing function may be moving image capturing, and image capturing in the second image capturing function may be still image capturing.

Further in the image capturing apparatus in the first aspect of the present invention,

image capturing in the first image capturing function may be still image capturing, and image capturing in the second image capturing function may be moving image capturing.

In this case, if the second operation member is operated during moving image capturing, the moving image capturing may be stopped.

In order to solve the aforementioned problem, a second aspect of the present invention is to provide an image capturing method in an image capturing apparatus which includes a function switch section for switching at least first and second image capturing functions, a first operation member which is operated to start image capturing in the first image capturing function or the second image capturing function and a second operation member which is operated to execute functions other than the first and second image capturing functions, comprising the steps of:

switching to the first image capturing function by operating the function switch section; and

executing image capturing in the second image capturing function by operating the second operation member on condition that the function switch section is switched to execute the first image capturing function.

In the image capturing method in the second aspect of the present invention,

image capturing in the second image capturing function may be executed when the first operation member is operated at the same time as the second operation member is operated on condition that the function switch section is switched to execute the first image capturing function.

Further in the image capturing method in the second aspect of the present invention,

image capturing in the second image capturing function may be executed when the first operation member is operated in a specified period of time after the second operation member is operated in the state of being switched to the first image capturing function.

Further in the image capturing method in the second aspect of the present invention,

the first operation member may be a release button, and the second operation member may be a button other than the release button.

Further in the image capturing method in the second aspect of the present invention,

the function switch section may be a rotating or sliding-type operation member.

Further in the image capturing method in the second aspect of the present invention, switching to the first image capturing function by the operation of the function switch section may be composed of the steps of:

displaying a plurality of function items in a display section provided in the image capturing apparatus; and

selecting and determining an item of the first image capturing function among from a plurality of the function items with use of a function selection member and a direction indication member that constitute the function switch section.

Further in the image capturing method in the second aspect of the present invention,

image capturing in the first image capturing function may be moving image capturing, and image capturing in the second image capturing function may be still image capturing.

Further in the image capturing method in the second aspect of the present invention,

image capturing in the first image capturing function may be still image capturing, and image capturing in the second image capturing function may be moving image capturing.

In this case, moving image capturing may be stopped by operating the second operation member during moving image capturing.

According to the image capturing apparatus and the image capturing method of the present invention, if the first operation member is operated, then image capturing in the first image capturing function selected by a function switch section is started, whereas if the second operation member is operated, then the first image capturing function selected by the function switch section is switched to the second image capturing function. Therefore, without the necessity of switching by the function switch section, the first image capturing function and the second image capturing function may be instantly switched.

Moreover, the first operation member is used in a general way, e.g., used for start/stop of moving image capturing in the moving image mode while used for sill image capturing in the still image mode. Therefore, in a generally use, the first operation member is operated normally, preventing operation mistakes from occurring.

Moreover, the second operation member was structured to be operated only when users desire irregular. image capturing, i.e., image capturing in a function different from that set in the function switch section. Consequently, for users unaccustomed to operation method, absence of unnecessary operation members decreases confusion in operation or possibility of misoperation.

Further, only one first operation member (e.g., release button) is sufficient enough. More specifically, the operation member operated during image capturing in a set image capturing function is not required to be plural, so that it is most appropriate for a small-size image capturing apparatus having no spare space for disposing more buttons, and it causes no mechanical cost increase.

### BRIEF DESCRIPTION OF THE DRAWINGS

The present invention will be further described with reference to the accompanying drawings wherein like reference numerals refer to like parts in the several views, and wherein:

FIG. 1 is a perspective view showing a digital camera in a first embodiment viewed from the rear side;

FIG. 2 is an enlarged view showing a mode dial;

FIG. 3 is a function block diagram showing the digital camera;

FIG. 4 is a block diagram showing an internal structure of a control section;

FIG. 5 is an explanatory view showing an image record in a memory card;

FIG. 6 is an enlarged view showing another example of the mode dial:

FIG. 7 is a perspective view showing a digital camera in a second embodiment viewed from the rear side;

FIG. 8 is a main flowchart showing control executed by the control section of the camera;

FIG. 9 is a flowchart showing processing A of FIG. 8;

FIG. 10 is a flowchart showing processing B of FIG. 8; and

FIGS. 11A and 11B are views showing one example of a pointing device.

### DETAILED DESCRIPTION OF THE PREFERRED EMBODIMENTS

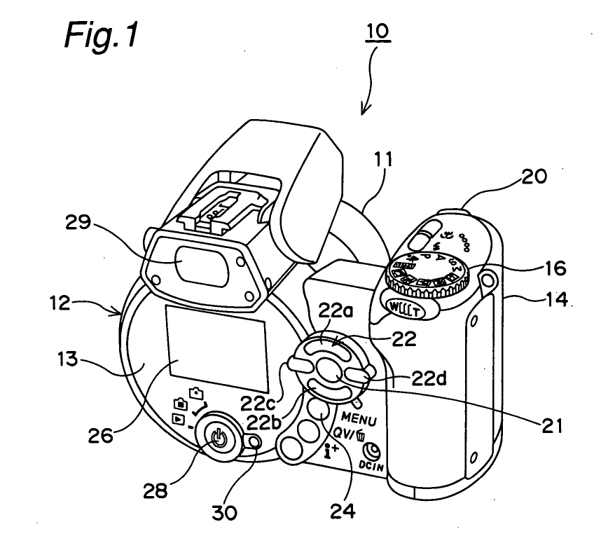

FIG. 1 is a perspective view showing a digital camera 10 in a first embodiment of the present invention viewed from the rear side. The digital camera 10 has a camera body 12. A barrel section 11 is protruded from the front surface of the camera body 12. Moreover, a grip section 14 in an almost oval cylinder shape is provided on an end portion of the camera body 12.

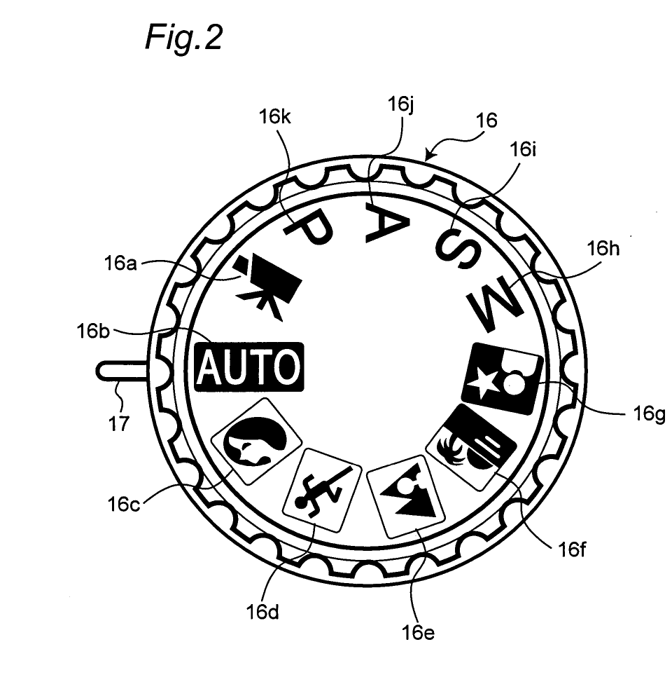

On the top portion of the grip section 14, disposed is a mode dial (function switch section) 16 that is a rotating-type operation member. The mode dial 16 is for users to switch the image capturing mode by rotating it. As shown in FIG. 2, 11 types of pictographic indications are printed on the upper surface of the mode 16. By aligning a desired pictographic indication with an index 17 formed on the upper surface of the grip section 14 by rotating the mode dial 16, users can switch a still image capturing mode and a moving image capturing mode. An pictographic indication 16a denotes a moving image capturing mode, whereas all the pictographic indications 16b to 16k other than the pictographic indication 16a represent still image capturing modes, which are switched and used by users depending on purposes. Herein, the pictographic indication 16b denotes a full auto mode, the pictographic indication 16c denotes a portrait scene mode, the pictographic indication 16d denotes a sport scene mode, the pictographic indication 16edenotes a landscape scene mode, the pictographic indication 16f denotes twilight scene mode, the pictographic indication 16g denotes a night scene mode, the pictographic indication 16h denotes a manual mode for manual setting of an iris and a shutter speed, the pictographic indication 16i denotes a shutter speed priority mode, the pictographic indication 16j denotes an iris priority mode, and the pictographic indication 16k denotes a program mode for automatic setting of an iris and a shutter speed by program shift.

It is to be noted that it is possible to use the mode dial 16 to allow switching of three or more types of image capturing modes including the still image capturing and the moving image capturing, or to allow switching to, for example, a voice recording mode as a function other than the image capturing modes.

On the upper front side of the grip section 14, a release button 20 is disposed as a first operation member. The release button 20 is a button which is operated for starting or stopping the image capturing. More specifically, in the still image capturing mode, the release button 20 is pressed to perform the still image capturing, whereas in the moving image capturing mode, the release button is pressed once to start the moving image capturing and the release button 20 is pressed one more time to stop the moving image capturing.

On a rear surface 13 of the camera body 12, there are disposed a round-shaped execution button (function selection member) 21, a cross button (direction indication member) 22 that is composed of an upper button 22a, a lower button 22b, a left button 22c and a right button 22d disposed in upper, lower, left and right portions of the execution button 21, respectively, and that has a direction indication function or the like, a menu button 24 disposed below the cross button 22, and a display section 26 which is disposed beside the cross button 22 and is composed of for example, a liquid crystal display. The menu button (function selection member) 24 is a button which is operated for a function to access into the display section 26 a menu panel for setting operation of the camera 10 and the like. Moreover, the execution button 21 is a button which is operated for a function to determine menu select items to be displayed in the display section 26 and a function to start/end reproduction of recorded moving images. Furthermore, the cross button 22 is a button which is operated for a function to select recorded still images displayed in the display section 26 and a function to switch setting values in the hierarchy of the menu displayed in the display section 26.

In the digital camera 10 of the present embodiment, the upper button 22a and the lower button 22b in the cross button 22 do not have any function in either the still image capturing mode or the moving image capturing mode. Therefore, in the digital camera 10, the upper button 22a is used, for example, as a second operation member, whose function will be described later.

It is to be noted that in the digital camera 10 of the present embodiment, it is possible as a function of the execution button 21 to select a focus area (spot or wide) if users keep on pressing the button during the still image capturing mode and the moving image capturing mode. If this function is arranged to be executed with use of another button such as the upper button 22a or the lower button 22b, the execution button 21 can be also used as the second operation member. In this case, there is an advantage that using the execution button 21 as the second operation member is more user-friendly than using the upper button 22a or the lower button 22b as the second operation member in terms of the shape and disposition location.

Moreover, in the case of using the execution button 21 as the second operation member, allowing the button to be operated in two steps (e.g., half pressing and full pressing, or touch and full pressing) makes it possible to provide the camera with an auto focus function during operation of the first step (i.e., half pressing or touch). In this case, except when the button is operated as the second operation member, either the first step operation or the second step operation should be detected.

The digital camera 10 further has a main switch 28 that is a button for turning on/off a power supply of the camera, and an image capturing/reproduction switch lever 30 that is a lever switch for switching between an image capturing mode and a reproduction mode and for switching between a display section 26 and a view finder 29, disposed on the rear surface 13 of the camera body 12. The reproduction mode herein refers to a function to reproduce a still image or a moving image which has already captured and recorded in the display section 26. In this embodiment, as described above, setting of the operation of the camera and the like is performed with the menu button 24, the execution button 21 and the cross button 22. Consequently, these buttons as well as the mode dial 16 and the image capturing/reproduction switch lever 30 constitute the function switch section.

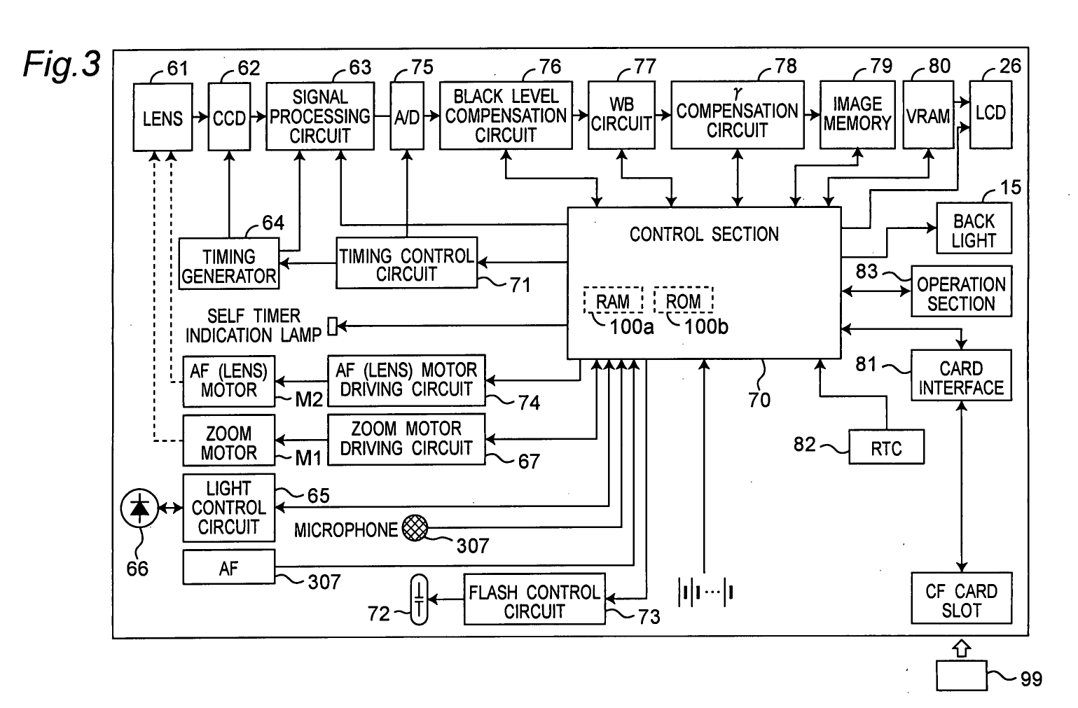

FIG. 3 is a function block diagram showing the digital camera 10. A CCD 62 photoelectrically transfers an optical image of a subject formed by a zoom lens 61 to an image signal (a signal composed of a signal sequence of a pixel signal received in each pixel) having color components of R (red), G (Green) and B (blue) and outputs the transferred signal.

A timing generator 64 is for generating a driving control signal of the CCD 62 based on a reference clock transmitted from a timing control circuit 71. The timing generator 64 generates clock signals such as timing signals for integral start/end (exposure start/end) and read control signals for receiving signals of each pixel (e.g., horizontal synchronization signals, vertical sync signals and transfer signals), and outputs the clock signals to the CCD 62.

A signal processing circuit 63 is for performing prescribed analog signal processing on an image signal (analog signal) outputted from the CCD 62. The signal processing circuit 63 includes a CDS (Correlated Double Sampling) circuit and an AGC (Auto Gain Control) circuit. Noise of the image signal is reduced by the CDS circuit, while a level of the image signal is adjusted by adjusting a gain of the AGC circuit.

A light control circuit 65 is for controlling the amount of light emitted by a built-in flash 72 in flash image capturing to be within a specified emitted light amount that is set by a control section 70. In the flash image capturing, flash light reflected on a subject is received by a light control sensor 66 in concurrence with start of exposure. When the amount of the received light reaches a specified emitted light amount, a light emission terminating signal is outputted from the light control circuit 65 to the control section 70. A flash control circuit 73 forcibly terminates light emission by the built-in flash 72 in response to the light emission termination signal, and this restrains the amount of light emitted by the built-in flash 72 within a specified emitted light amount.

An A/D conversion section 75 is for converting each pixel signal of an image signal to a 10-bit digital signal. Moreover, a timing control circuit 71 generates a clock to the A/D conversion section 75. The timing control circuit 71 is controlled by the control section 70.

A black level compensation circuit 76 is for compensating a black level of an A/D converted pixel signal (hereinbelow referred to as pixel data). Moreover, a WB circuit 77 is for performing level conversion of pixel data of each color component of R, G and B so that a white balance is adjusted together after γ compensation. The WB circuit 77 converts the level of pixel data of each color component of R, G and B with use of a level conversion table inputted from the control section 70. It is to be noted that a conversion coefficient (gradient of characteristic) of each color component in the level conversion table is set per image capturing pixel by the control section 70.

A γ compensation circuit 78 is for compensating γ characteristic of pixel data. An image memory 79 is a memory for storing pixel data outputted from the γ compensation circuit 78. The image memory 79 has a storage capacity for one frame. More specifically, if the CCD 62 has pixels of n lines and m rows, the image memory 79 has a storage capacity for pixel data of n×m pixels, and each pixel data is stored in a corresponding pixel location.

A VRAM 80 is a buffer memory for image data reproduced and displayed in the display section (LCD) 26. The VRAM 80 has a storage capacity for the image data corresponding to the number of pixels in the display section 26.

The number of pixels displayed in the display section 26 is 400×300 pixels, for example. Consequently, in an image capturing standby state during the image capturing mode, image data from the CCD 62 is decimated to ¼ and read out in the timing control circuit 71 and the timing generator 64, and then each pixel data on an image picked up at prescribed intervals undergoes specified signal processing performed through from the A/D conversion section 75 to the γ compensation circuit 78. After that, each pixel data is stored in the image memory 79 while being transferred to the VRAM 80 via the control section 70 and displayed in the display section 26 (live view display). This enables a user to visually identify a subject image with the image displayed in the display section 26. Moreover, during the reproduction mode, an image read out from a memory card 99 undergoes specified signal processing performed by the control section 70, and then the image is transferred to the VRAM 80 and reproduced and displayed in the display section 26.

A card interface 81 is an interface for writing and reading image data onto/from the memory card 99.

The flash control circuit 73 is a circuit for controlling light emission from the built-in flash 72. Based on a control signal from the control section 70, the flash control circuit 73 controls the presence or absence of light emission, the amount of emitted light, light emission timing and the like of the built-in flash 72, and controls the amount of light emitted from the built-in flash 72 based on a light emission terminating signal inputted from the light control circuit 65.

A RTC 82 is a clock circuit for managing image capturing time and date and is driven by unshown another power supply. Moreover, an operation section 83 includes aforementioned various switches and buttons.

The release button 20 is a two-step switch, which allows detection of a half-pressing state (S1) and a full-pressing state (S2) as employed in silver-salt cameras. If the release button 20 is put into the S1 state in the standby state, distance measurement information is inputted into the control section 70 according to distance measurement information from a distance-measuring sensor. Based on an instruction of the control section 70, an AF driving circuit 74 drives an AF motor M2, and moves an image capturing lens 61 to a focus position.

The control section 70 is composed of a CPU, and organically controls the above-described members or elements in the digital camera 10 to generally control the image capturing motion of the digital camera 10. It is to be noted that the arrows indicated by dotted lines in FIG. 3 denote the flows of image data for convenience sake. In reality, the image data is transmitted to each block through the control section 70. For that purpose, the control section 70 includes a working memory 100a composed of DRAM and a flush ROM 100b for storing the program.

The control section 70 is composed of a luminance determination section 70a and a shutter speed setting section 70b for setting an exposure control value (shutter speed (SS)). The luminance determination section 70a is for determining the luminance of a subject by utilizing an image captured every 1/30 second by the CCD 62 in the standby state. More specifically, the luminance determination section 70a is for determining the luminance of a subject by utilizing image data that is stored in the image memory 79 in an updated manner.

The shutter speed setting section 70b is for setting a shutter speed (integral time of CCD) based on the determination result regarding the luminance of a subject by the luminance determination section 70a.

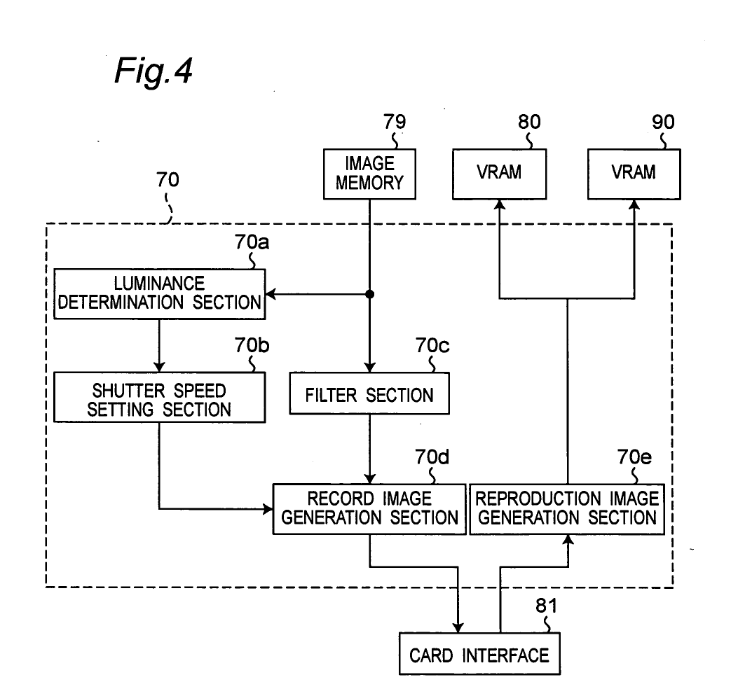

Further, as shown in FIG. 4, the control section 70 has a filter section 70c for performing filtering processing and a record image generation section 70d for generating thumbnail images and compressed images in order to perform recording processing on the captured image, as well as has a reproduction image generation section 70e for generating reproduction images in order to reproduce images recorded in the memory card 99 in the display section 26. The filter section 70c is for compensating a high-frequency component of an image to be recorded with use of a digital filter in order to perform image compensation in terms of an outline.

Description is now given of the operation of still image capturing and moving image capturing in the digital camera 10.

During still image capturing, the record image generation section 70d reads image data from the image memory 79 and generates a thumbnail image and a compressed image to be recorded in the memory card 99. More specifically, the record image generation section 70d reads pixel data by every eight pixels both in horizontal and vertical directions while scanning the data in raster scan direction from the image memory 79, and sequentially transfers the data to the memory card 99, so that a thumbnail image is generated while being recorded in the memory card 99.

For recording data in the memory card 99, all the pixel data is read from the image memory 79, and is subjected to specified compressing processing of JPEG method such as two-dimensional DCT conversion and Huffman coding.

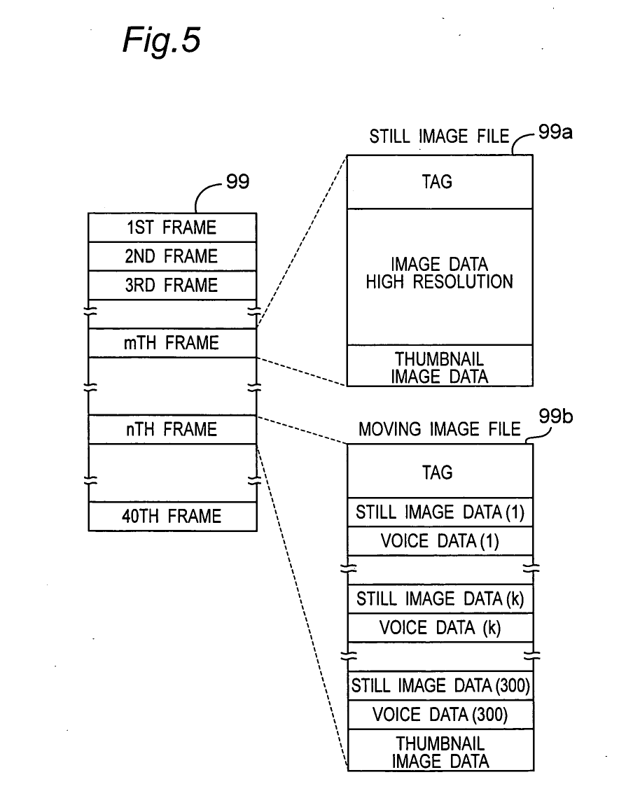

In the image capturing mode, in response to the instruction of image capturing from the release button 20, the control section 70 reads image data from the CCD 62 in the timing control circuit 71 and the timing generator 64 without decimation and performs the aforementioned processing. Then, the control section 70 generates a thumbnail image and a compressed image of the image data, the compressed image being compressed by JPEG method at a compression ratio set by a compression rate setting switch. These images are stored along with tag information on a captured image (frame number, exposure value, shutter speed, compression rate, image capturing date, data on flash on/off at the time of image capturing, scene information, and information including determination result regarding the image), as a still image file (frame) 99a in the memory card 99 (see FIG. 5).

The still image file 99a contains a tag portion, high-resolution image data compressed by JPEG method (1600×1200 pixels), and image data for thumbnail indication (80×60 pixels). An image data capacity for one file is about 1 MB.

During moving image capturing, an image data size is decimated to ¼, so that data of 400×300 pixels is captured, processed and recorded in the memory card 99.

Similarly to the image capturing standby operation, image data captured every 1/30 second is subjected to compressing processing as still image data compressed by JPEG method when the release button 20 is pressed (in S2), and is arrayed alternately with voice data that is recorded for 1/30 second to constitute a moving image file. As with the case of the still image file, the data is provided with a tag and a thumbnail and is recorded in the memory card 99 as one moving image file 99b (see FIG. 5).

Description is now given of a modified example of the digital camera 10 in the first embodiment.

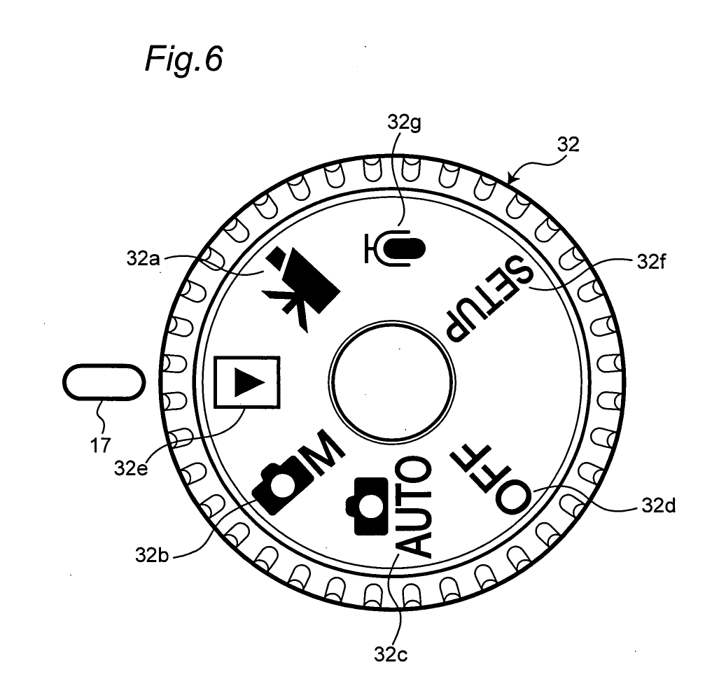

The outward appearance of a digital camera in this modified example is almost identical to the aforementioned digital camera 10 and so its overall drawing is omitted. The main difference of this modified example is the point that a mode dial 32 shown in FIG. 6 is provided. The mode dial (function switch section) 32, that is a rotating-type operation member, combines the main switch 28, the image capturing/reproduction switch lever 30 and a part of items set in the hierarchy of the menu read by the menu button 24 in the digital camera 10. More specifically, a pictographic indication 32a denotes a moving image capturing mode, and a pictographic indications 32b and 32c denote still image capturing modes, while other pictographic indications denote modes respectively representing power off (32d), reproducing (32e), setup (32f) and voice recording (32g). By aligning each pictographic indication with an index 17 by rotating the mode dial 32, each mode of the digital camera is switched.

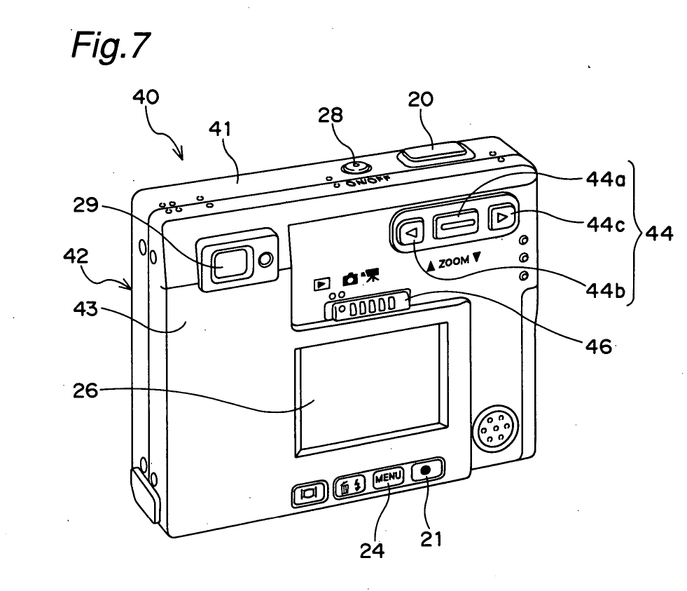

Description is now given of a digital camera 40 in a second embodiment of the present invention with reference FIG. 7.

It is to be noted that members having functions identical to those of the digital camera 10 in the first embodiment are designated by identical reference numerals and detailed description thereof is omitted.

FIG. 7 is a perspective view showing the digital camera 40 viewed from the rear side. The digital camera 40 has a camera body 42 made of a thin oblong casing. The camera body 42 incorporates a curved optical system barrel unit so that a barrel section is not protruded from the camera body 42 during image capturing.

On an upper surface 41 of the camera body 42, a release button 20 exemplifying a first operation member and a main switch 28 are disposed. Moreover, on a rear surface 43 of the camera body 42, there are disposed a cross button (direction indication member) 44 composed of an upper and lower lever 44a, a left button 44b and a right button 44c, a mode switch lever (function switch section) 46 exemplifying a sliding-type operation member, an execution button 21, a menu button 24 and a display section 26. The upper and lower lever 44a is equivalent to the upper button 22a and the lower button 22b of the digital camera 10. Moreover, the mode switch lever 46, if slid to the left side of the drawing, is switched to a reproduction mode, whereas if slid to the right side of the drawing, it is switched to an image capturing mode. In this case, when it is switched to the image capturing mode, the camera is normally in a still image capturing mode. For switching it to a moving image capturing mode, the menu button 24 is pressed to display a menu panel in the display section 26, and the moving image capturing mode in the hierarchy of a menu is selected by using the cross button 44 and confirmed by the execution button 21. Therefore, in the present embodiment, in addition to the mode switch lever 46, the execution button 21, the menu button 24 and the cross button 44 constitute the function switch section.

In the digital camera 40 of the present invention, the left button 44b and the right button 44c in the cross button 44 do not have any function in either the still image capturing mode or the moving image capturing mode. Therefore, in the digital camera 40, the right button 44c is used, for example, as a second operation member, whose function will be described later.

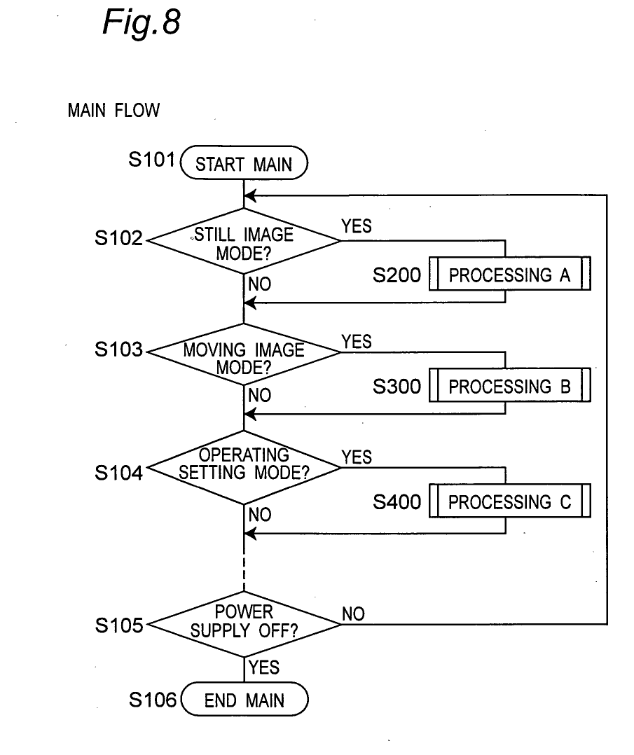

Description is now given of the operation of the digital camera 10 in the first embodiment and the modified example thereof as well as the digital camera 40 in the second embodiment with reference to FIGS. 8-10 which show control flows executed in the control section 70 incorporated in each camera. It is to be noted that in reality, the order and the content of mode switching in the aforementioned each camera might be partially different, or a plurality of still image capturing modes might be present, so that actual flows are different from those disclosed herein in the strict sense. However, since the difference does not concern the essential characteristics of the present invention, the flow is deemed as containing either embodiment and the content thereof is described below.

As shown in FIG. 8, once a main routine is started (step S101), first, it is determined whether or not the current mode is a still image capturing mode (step S102). If the mode is not switched to the still image capturing mode, then the procedure proceeds to a step S103, whereas if it is switched to the still image capturing mode, then later-described processing A (step S200) is executed and the procedure proceeds to the step S103.

Next, it is determined whether or not the current mode is a moving image capturing mode (step S103). If the mode is not switched to the moving image capturing mode, then the procedure proceeds to a step S104, where if it is switched to the moving image capturing mode, then later-described processing B (step S300) is executed and the procedure proceeds to the step S104.

Next, it is determined whether or not the current mode is an operation setting mode (step S104). If the mode is not switched to the operation setting mode, then the procedure proceeds to a step S105, whereas if it is switched to the operation setting mode, then processing C (step S400) is executed and the procedure proceeds to a step S105.

It is to be noted that a part of a line between the step S104 an the step S105 is shown with a broken line to indicate that if other modes such as voice recording mode are present, determination on switching to the other modes and processing thereof is executed herein.

Then, at last, it is determined whether or not a power supply is turned off (step S105). If the power supply is turned off, then the main flow is terminated (step S106), whereas if the power supply is not turned off, then the procedure returns to the step S102.

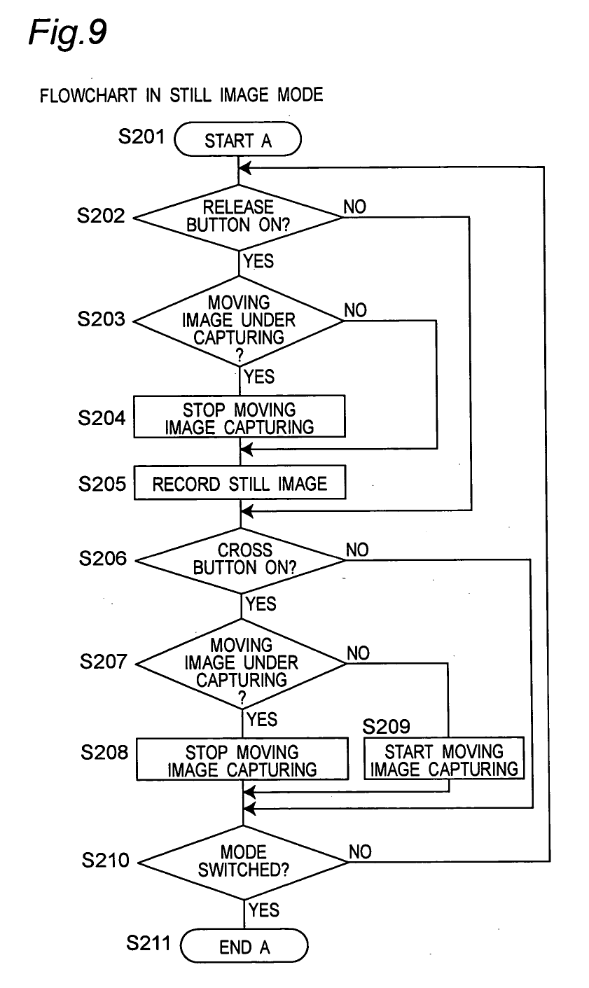

Description is now given of the processing A in the still image capturing mode with reference to FIG. 9.

Once the processing is started (step S201), first, it is determined whether or not the release button 20 is pressed (step S202). If it is not pressed, then the procedure proceeds to a step S206. If the release button 20 is pressed, then it is determined whether or not a moving image is under capturing (step S203). If the moving image is under capturing, then the moving image capturing is stopped (step S204), and then a still image is captured and recorded (step S205). If the moving image is not under capturing, then a still image is immediately captured and recorded (step S205).

Next, it is determined whether or not the cross button (e.g., the upper button 22a or the right button 44c) is pressed (step S206). If it is not pressed, then the procedure proceeds to a step S210. If the cross button is pressed, then it is determined whether or not a moving image is under capturing (step S207). If the moving image is not under capturing, moving image capturing is started (step S209), whereas if the moving image is under capturing, moving image capturing is stopped (step S208).

Then, it is determined whether or not the mode is switched (step S210). If the mode is switched, then the processing A is ended (step S211), whereas if the mode is not switched, then the procedure returns to the step S202.

Thus, during the still image capturing mode, the release button 20 is pressed to perform the still image capturing, whereas the cross button is pressed once to start the moving image capturing and the cross button is pressed one more time to stop the moving image capturing.

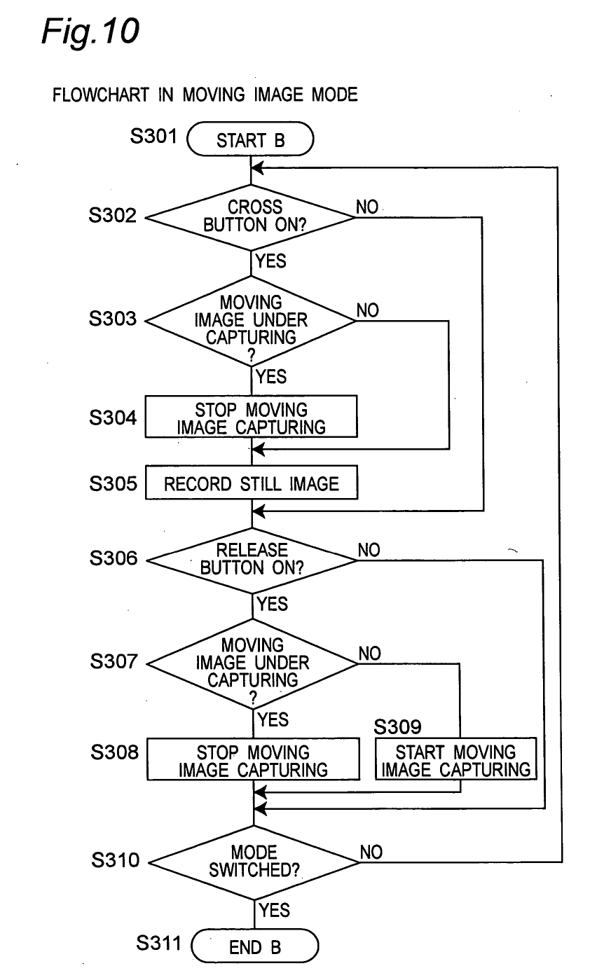

Description is now given of the processing B in the moving image capturing mode with reference to FIG. 10.

Once the processing is started (step S301), first, it is determined whether or not the cross button (e.g., the upper button 22a or the right button 44c) is pressed (step S302). If it is not pressed, then the procedure proceeds to a step S306. If the cross button is pressed, then it is determined whether or not a moving image is under capturing (step S303). If the moving image is under capturing, then the moving image capturing is stopped (step S304) and then a still image is captured and recorded (step S305). If the moving image is not under capturing, the still image is immediately captured and recorded (step S305).

Next, it is determined whether or not the release button 20 is pressed (step S306). If it is not pressed, then the procedure proceeds to a step S310. If the release button 20 is pressed, then it is determined whether or not a moving image is under capturing (step S307). If the moving image is not under capturing, then moving image capturing is started (step S309), whereas if the moving image is under capturing, then moving image capturing is stopped (step S308).

Then, it is determined whether or not the mode is switched (step S310). If the mode is switched, then the processing B is ended (step S311), whereas if the mode is not switched, then the procedure returns to the step S302.

Thus, during the moving image capturing mode, the release button 20 is pressed once to start moving image capturing, and the release button 20 is pressed one more time to stop the moving image capturing, whereas the cross button is pressed to perform still image capturing.

It is to be noted that in the above-stated processing A (or processing B), if the release button (or the cross button) is pressed during moving image capturing to perform still image capturing, then the moving image capturing is cancelled. However in this case, the moving image capturing may be automatically restarted after the still image capturing.

It is to be noted that detailed description of the processing C in the operation setting mode is omitted.

As described above, according to the digital camera in each embodiment, operating the release button 20 starts image capturing in the still image capturing mode (or the moving image capturing mode) selected with the mode dials 16, 32 and the mode switch lever 46. By operating the cross buttons 22, 44, image capturing in the moving image capturing mode (or the still image capturing mode) selected by the mode dials 16, 32 and the like is switched to image capturing in the still image capturing mode (or the moving image capturing mode). Therefore, it becomes possible to instantly switch between the still image capturing mode and the moving image capturing mode through operation of the cross buttons 22, 44 without switching the mode with the mode dials 16, 32 and the like.

Moreover, the release button 20 is used in a general way, i.e., used for start/end of moving image capturing in the moving image capturing mode while used for sill image capturing in the still image capturing mode. Therefore, in a generally use, the release button 20 is operated normally, preventing operation mistakes from occurring.

Moreover, the cross buttons 22, 44 were structured to be operated only when users desire irregular image capturing, i.e., image capturing in a mode different from that set with the mode dials 16, 32 and the like. Consequently, for users unaccustomed to operation method, absence of unnecessary operation members decreases confusion in operation or possible misoperation.

Further, only one release button 20 is sufficient enough. More specifically, the operation member operated during image capturing in a set image capturing mode is not required to be plural, so that it is most appropriate for a small-size image capturing apparatus having no spare space for disposing more buttons, and it causes no mechanical cost increase.

In the above description, description has been given of the example of performing moving image capturing in the still image capturing mode or performing still image capturing in the moving image capturing mode. However, the present invention is not restrict to this example, and therefore in the case of, for example, a camera having a voice recording function, it is also possible to perform still image capturing or moving image capturing during the voice recording mode. Further, it is also possible to provide a function to allow still image capturing by pressing the upper button 22a and moving image capturing by pressing the lower button 22b during the voice recording mode.

In the above description, an operation member (e.g., the cross buttons 22, 44) different from the release button 20 is operated singly so as to achieve image capturing in a mode other than a set mode. However, the release button 20 may be pressed while the different operation member is operated (pressed), so that the image capturing in the mode other than the set mode is operated. For example, in moving image capturing during the still image capturing mode, this operation may be executed for starting and stopping the moving image capturing. Such arrangement is effective as it allows prevention of unintentional image capturing when there is the possibility of accidentally operating a different operation member due to the construction of the device.

Alternatively, after operation of the another operation member, the release button 20 may be pressed in a specified period of time, so that image capturing in the mode other than the set mode is achieved. This arrangement is effective when the aforementioned different operation member can be disposed only in a position or in a shape that is structurally hard to operate, in a position that tends to cause hand trembling, or in a position that is hard to operate concurrently with the release button 20 as described above.

Although in the above description, the cross buttons 22, 44 are operation members, it is not restrictive and therefore still another operation member may be used as a second operation member.

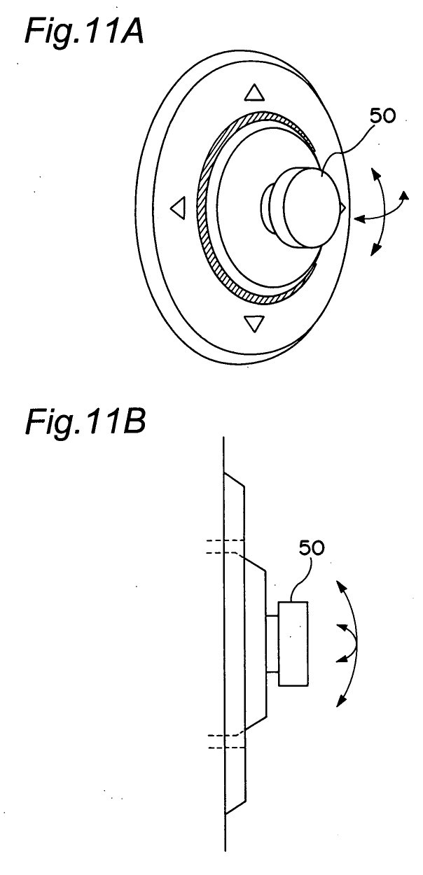

Moreover, in the above description, the direction indication member was embodied by the cross buttons 22, 44. However, without being limited thereto, the direction indication member may be embodied by other members such as pointing devices and embedded rotating balls. In this case, the pointing devices may be those of so-called joy sticks capable of indicating the direction with a protruding lever 50 being inclined at least in four directions of up, down, left and right as shown in FIGS. 11A and 11B.

Furthermore, although the digital cameras have been described as examples in the above description, the present invention is also applicable to image capturing apparatuses such as digital videos and cell phones with camera.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

1. An image capturing apparatus for capturing and recording images, comprising:
a function switch section for switching at least first and second image capturing functions;
a first operation member which is operated to start capturing images in the first image capturing function or the second image capturing function; and
a second operation member which is operated to execute functions other than the first and second image capturing functions, wherein
on condition that the function switch section is switched so as to execute image capturing in the first image capturing function in response to operation of the first operation member, image capturing in the second image capturing function is executed when the second operation member is operated.

2. The image capturing apparatus as defined in claim 1, wherein
on condition that the function switch section is switched so as to execute image capturing in the first image capturing function in response to operation of the first operation member, image capturing in the second image capturing function is executed when the first operation member is operated at the same time as the second operation member is operated.

3. The image capturing apparatus as defined in claim 1, wherein
on condition that the function switch section is switched so as to execute image capturing in the first image capturing function in response to operation of the first operation member, image capturing in the second image capturing function is executed when the first operation member is operated in a specified period of time after the second operation member is operated.

4. The image capturing apparatus as defined in claim 1, wherein
the first operation member is a release button, and the second operation member is a button other than the release button.

5. The image capturing apparatus as defined in claim 1, wherein
the function switch section is a rotating or sliding-type operation member.

6. The image capturing apparatus as defined in claim ,1 wherein
the function switch section is composed of a function selection member for selecting and determining a function and a direction indication member for indicating a direction, and switching of functions by the function switch section is achieved by selecting and determining items that are displayed in a display section provided in the image capturing apparatus with use of the function selection member and the direction indication member.

7. The image capturing apparatus as defined in claim 1, wherein
image capturing in the first image capturing function is moving image capturing, and image capturing in the second image capturing function is still image capturing.

8. The image capturing apparatus as defined in claim 1, wherein
image capturing in the first image capturing function is still image capturing, and image capturing in the second image capturing function is moving image capturing.

9. The image capturing apparatus as defined in claim 8, wherein
by operating the second operation member during moving image capturing, the moving image capturing is stopped.

10. An image capturing method in an image capturing apparatus which includes a function switch section for switching at least first and second image capturing functions, a first operation member which is operated to start image capturing in the first image capturing function or the second image capturing function and a second operation member which is operated to execute functions other than the first and second image capturing functions, comprising the steps of:
switching to the first image capturing function by operating the function switch section; and
executing image capturing in the second image capturing function by operating the second operation member on condition that the function switch section is switched to execute the first image capturing function.

11. The image capturing method as defined in claim 10, wherein
image capturing in the second image capturing function is executed when the first operation member is operated at the same time as the second operation member is operated on condition that the function switch section is switched to execute the first image capturing function.

12. The image capturing method as defined in claim 10, wherein
image capturing in the second image capturing function is executed when the first operation member is operated in a specified period of time after the second operation member is operated on condition that the function switch section is switched to execute first image capturing function.

13. The image capturing method as defined in claim 10, wherein
the first operation member is a release button, and the second operation member is a button other than the release button.

14. The image capturing method as defined in claim 10, wherein
the function switch section is a rotating or sliding-type operation member.

15. The image capturing method as defined in claim 10, wherein
switching to the first image capturing function by the operation of the function switch section is composed of the steps of:
displaying a plurality of function items in a display section provided in the image capturing apparatus; and
selecting and determining an item of the first image capturing function among from a plurality of the function items with use of a function selection member and a direction indication member that constitute the function switch section.

16. The image capturing method as defined in claim 10, wherein
image capturing in the first image capturing function is moving image capturing, and image capturing in the second image capturing function is still image capturing.

17. The image capturing method as defined in claim 10, wherein
image capturing in the first image capturing function is still image capturing, and image capturing in the second image capturing function is moving image capturing.

18. The image capturing method as defined in claim 17, further comprising the step of
stopping moving image capturing by operating the second operation member during moving image capturing.
